(19) United States
(12) Patent Application Publication
(10) Pub. No.: US 2022/0284600 A1
(43) Pub. Date: Sep. 8, 2022

(54) USER IDENTIFICATION IN STORE ENVIRONMENTS

(71) Applicant: Inokyo, Inc., San Francisco, CA (US)

(72) Inventors: Ryan Patrick BRIGDEN, Menlo Park, CA (US); Tony FRANCIS, San Francisco, CA (US)

(21) Appl. No.: 17/193,851

(22) Filed: Mar. 5, 2021

(51) Int. Cl. G06T 7/292; G06T 7/246; G06T 7/73; G06T 7/80; G06Q 30/06

(52) U.S. Cl. CPC G06T 7/292; G06T 7/251; G06T 7/75; G06T 7/85; G06Q 30/0635; G06K 9/00335

(57) ABSTRACT

One embodiment of the present invention sets forth a technique for identifying users. The technique includes generating a first set of image crops of users in an environment based on estimates of a first set of poses for the users in a first set of images collected by a set of tracking cameras. The technique also includes applying an embedding model to the first set of image crops to produce a first set of embeddings and aggregating the first set of embeddings into clusters representing the users. The technique further includes upon matching, to a cluster, a second set of embeddings produced by the embedding model from a second set of image crops of an interaction between a user and an item, storing a representation of the interaction in a virtual shopping cart associated with the cluster.

### BACKGROUND

### Field of the Various Embodiments

Embodiments of the present disclosure relate generally to autonomous store, and more specifically, to user identification in store environments.

### Description of the Related Art

Autonomous store technology allows customers to select and purchase items from stores, restaurants, supermarkets, and/or other retail establishments without requiring the customers to interact with human cashiers or staff. For example, a customer may use a mobile application to “check in” at the entrance of an unmanned convenience store before retrieving items for purchase from shelves in the convenience store. After the customer is done selecting items in the convenience store, the customer may carry out a checkout process that involves scanning the items at a self-checkout counter, linking the items to a biometric identifier for the customer (e.g., palm scan, fingerprint, facial features, etc.), and/or charging the items to the customer's account.

However, a number of challenges are encountered in the deployment, use, and adoption of autonomous store technology. First, the check-in process at many autonomous stores requires customers to register or identify themselves via a mobile application. As a result, the convenience or efficiency of the autonomous retail customer experience may be disrupted by the need to download, install, and configure the mobile application on the customers' devices before the customers are able to shop at autonomous stores. Moreover, users that do not have mobile devices may be barred from shopping at the autonomous stores. The check-in process for an autonomous store may also, or instead, be performed by customers swiping payment cards at a turnstile, which interferes with access to the autonomous store for customers who wish to browse items in the autonomous store and/or limits the rate at which customers are able to enter the autonomous store.

Second, autonomous retail solutions are associated with a significant cost and/or level of resource consumption. For example, an autonomous store commonly includes cameras that provide comprehensive coverage of the areas within the autonomous store, as well as weight sensors in shelves that hold items for purchase. Data collected by the cameras and/or weight sensors is additionally analyzed in real-time using computationally expensive machine learning and/or computer vision techniques that execute on embedded machine learning processors to track the identities and locations of customers, as well as items retrieved by the customers from the shelves. Thus, adoption and use of an autonomous retail solution by a retailer may require purchase and setup of the cameras, sensors, and sufficient computational resources to analyze the camera and sensor data in real-time.

As the foregoing illustrates, what is needed in the art are techniques for improving the computational efficiency, deployment, accuracy, and customer experience of autonomous stores.

### SUMMARY

One embodiment of the present invention sets forth a technique for identifying users. The technique includes generating a first set of image crops of a set of users in an environment based on estimates of a first set of poses for the set of users in a first set of images collected by a set of tracking cameras. The technique also includes applying an embedding model to the first set of image crops to produce a first set of embeddings and aggregating the first set of embeddings into clusters representing the first set of users. The technique further includes upon matching, to a cluster, a second set of embeddings produced by the embedding model from a second set of image crops of an interaction between a user and an item, storing a representation of the interaction in a virtual shopping cart associated with the cluster.

At least one technological advantage of the disclosed technique is tracking of the users' movement and actions in the environment in a stateless, efficient manner, which reduces complexity and/or resource overhead over conventional techniques that perform tracking via continuous user tracks and require multi-view coverage throughout the environments and accurate calibration between cameras. Consequently, the disclosed techniques provide technological improvements in computer systems, applications, and/or techniques for uniquely identifying and tracking users, associating user actions with user identities, and/or operating autonomous stores.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A illustrates a system configured to implement one or more aspects of various embodiments.

FIG. 1B illustrates a system for processing video data captured by a set of cameras, according to various embodiments.

FIG. 2 is a more detailed illustration of a cluster node in the cluster of FIG. 1A, according to various embodiments.

FIG. 3 is a more detailed illustration of the training engine, tracking engine, and estimation engine of FIG. 2, according to various embodiments.

FIG. 4 is a flow chart of method steps for training an embedding model, according to various embodiments.

FIG. 5 is a flow chart of method steps for identifying users in an environment, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

System Overview

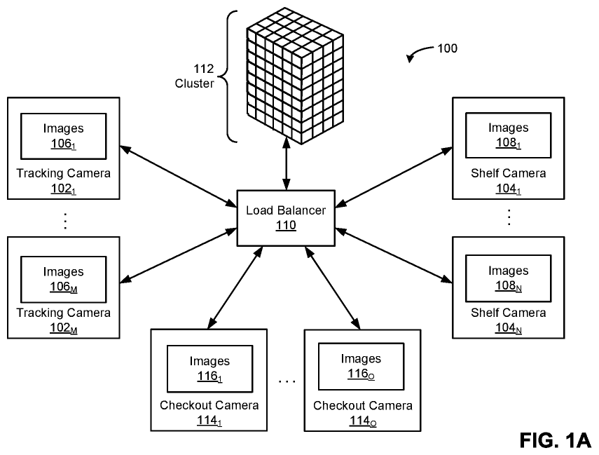

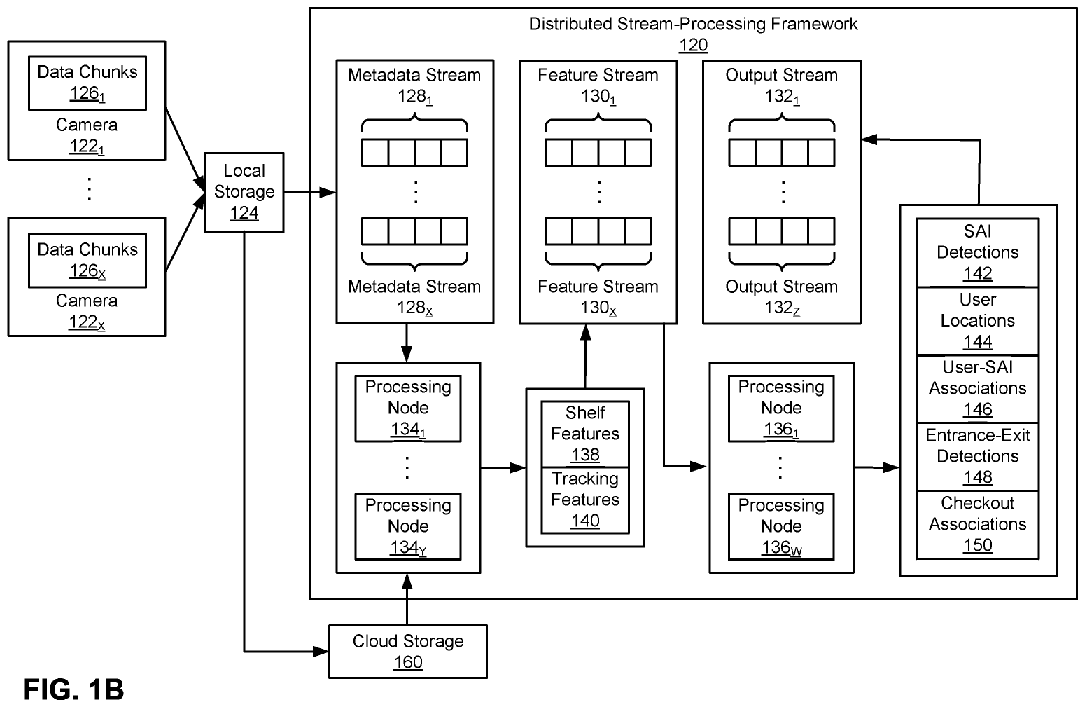

FIG. 1A illustrates a system 100 configured to implement one or more aspects of the present disclosure. In one or more embodiments, system 100 operates an autonomous store that processes purchases of items in a physical storefront. Within the autonomous store, users that are customers are able to retrieve and purchase the items without requiring the users to interact with human cashiers or staff.

As shown, system 100 includes, without limitation, a number of tracking cameras 102_{1-M}, a number of shelf cameras 104_{1-N}, and a number of checkout cameras 114_{1-O}. Tracking cameras 102_{1-M}, shelf cameras 104_{1-N}, and checkout cameras 114_{1-O} are connected to a load balancer 110, which distributes processing related to tracking cameras 102_{1-M}, shelf cameras 104_{1-N}, and checkout cameras 114_{1-O} among a number of nodes in a cluster 112. For example, tracking cameras 102_{1-M}, shelf cameras 104_{1-N}, and checkout cameras 114_{1-O} may send and/or receive data over a wired and/or wireless network connection with load balancer 110. In turn, load balancer 110 may distribute workloads related to the data across a set of physical and/or virtual machines in cluster 112 to optimize resource usage in cluster 112, maximize throughput related to the workloads, and/or avoid overloading any single resource in cluster 112.

Tracking cameras 102_{1-M} capture images 106_{1-M} of various locations inside the autonomous store. These images 106_{1-M} are analyzed by nodes in cluster 112 to uniquely identify and locate users in the autonomous store. For example, tracking cameras 102_{1-M} include stereo depth cameras that are positioned within and/or around the autonomous store. The stereo depth cameras capture overlapping views of the front room area of the autonomous store that is accessible to customers. In addition, each stereo depth camera senses and/or calculates depth data that indicates the distances of objects or surfaces in the corresponding view from the camera. Nodes in cluster 112 receive images 106_{1-M} and depth data from tracking cameras 102_{1-M} via load balancer 110 and analyze the received information to generate unique “descriptors” of the customers based on the representations of the customers in images 106_{1-M} and depth data. These descriptors are optionally combined with “tracklets” representing short paths of the customers' trajectories in the autonomous store to estimate the customers' locations within the camera views as the customers move around the autonomous store.

Shelf cameras 104_{1-N} capture images 108_{1-N} of interactions between customers and items on shelves of the autonomous store. These images 108_{1-N} are analyzed by nodes in cluster 112 to identify interactions between the customers and items offered for purchase on shelves of the autonomous store. For example, shelf cameras 104_{1-N} may be positioned above or along shelves of the autonomous store to monitor locations in the vicinity of the shelves. Like tracking cameras 102_{1-M}, shelf cameras 104_{1-N} may include stereo depth cameras that collect both visual and depth information from the shelves and corresponding items. Images 108_{1-N} and depth data from shelf cameras 104_{1-N} are received by cluster 112 via load balancer 110 and analyzed to detect actions like removal of an item from a shelf and/or placement of an item onto a shelf. In turn, the actions are associated with customers based on the customers' tracked locations and/or identities and used to update virtual shopping carts for the customers, as described in further detail below.

In various embodiments, checkout cameras 114_{1-O} capture images 116_{1-O} of checkout locations located near one or more exits of the autonomous store. For example, checkout cameras 114_{1-O} may be positioned above or along designated checkout “zones” or checkout terminals in the autonomous store. As with tracking cameras 102_{1-M} and shelf cameras 104_{1-N}, checkout cameras 114_{1-O} may include stereo depth cameras that capture visual and depth information from the checkout locations. Images 116_{1-O} and depth data from checkout cameras 114_{1-O} are received by cluster 112 via load balancer 110 and analyzed to identify customers in the vicinity of the checkout locations. Images 116_{1-O} and depth data from checkout cameras 114_{1-O} are further analyzed to detect actions by the customers that are indicative of checkout intent, such as the customers approaching the checkout locations. When a customer's checkout intent is detected from analysis of images 116_{1-O} and corresponding depth data for the customer, a checkout process is initiated to finalize the customer's purchase of items in his/her virtual shopping cart.

In some embodiments, checkout locations in the autonomous store include physical checkout terminals. Each checkout terminal includes hardware, software, and/or functionality to perform a checkout process with a customer before the customer leaves the autonomous store. For example, the checkout process may be automatically triggered for a customer when the customer's tracked location indicates that the customer has approached the checkout terminal.

During the checkout process, the checkout terminal and/or a mobile application on the customer's device display the customer's virtual shopping cart and process payment for the items in the virtual shopping cart. The checkout terminal and/or mobile application additionally output a receipt to the customer. For example, the checkout terminal displays the receipt in a screen to the customer to confirm that the checkout process is complete, which allows the customer to leave the autonomous store with the purchased items. In other words, the checkout process includes steps or operations for finalizing the customer's purchase of items in his/her virtual shopping cart.

In some embodiments, the checkout process processes payment after the customer leaves the autonomous store. For example, the checkout terminal and/or mobile application may require proof of payment (e.g., a payment card number) before the customer leaves with items taken from the autonomous store. The payment may be performed after the customer has had a chance to review, approve, and/or dispute the items in the receipt.

In some embodiments, the checkout process is performed without requiring display of the receipt in a physical checkout terminal in the autonomous store. For example, a mobile application that stores payment information for the customer and/or the mobile device on which the mobile application is installed may be used to initiate the checkout process via a non-physical localization method such as Bluetooth (Bluetooth™ is a registered trademark of Bluetooth SIG, Inc.), near-field communication (NFC), WiFi (WiFi™ is a registered trademark of WiFi Alliance), and/or a non-screen-based contact point. Once the checkout process is initiated, payment information for the customer from the mobile application is linked to items in the customer's virtual shopping cart, and the customer is allowed to exit the autonomous store without reviewing the items and/or manually approving the payment.

In some embodiments, system 100 is deployed and/or physically located on the premises of the autonomous store to expedite the collection and processing of data required to operate the autonomous store. For example, load balancer 110 and machines in cluster 112 may be located in proximity to tracking cameras 102_{1-M}, shelf cameras 104_{1-N}, and checkout cameras 114_{1-O} (e.g., in a back room or server room of the autonomous store that is not accessible to customers) and connected to tracking cameras 102_{1-M}, shelf cameras 104_{1-N}, and checkout cameras 114_{1-O} via a fast local area network (LAN). In addition, the size of cluster 112 may be selected to scale with the number of tracking cameras 102_{1-M}, shelf cameras 104_{1-N}, checkout cameras 114_{1-O}, items, and/or customers in the autonomous store. Consequently, system 100 may support real-time tracking of customers and the customers' shelf interactions via analysis of images 106_{1-M}, 108_{1-N}, and 116_{1-O}, updating of the customers' virtual shopping carts based on the tracked locations and interactions, and execution of checkout processes for the customers before the customers leave the autonomous store.

FIG. 1B illustrates a system for processing video data captured by a set of cameras 122_{1-X}, according to various embodiments. In some embodiments, cameras 122_{1-N} include tracking cameras 102_{1-M}, shelf cameras 104_{1-N}, and/or checkout cameras 114_{1-O} that capture different areas within a physical store. Cameras 122_{1-N} also, or instead, include one or more entrance/exit cameras that capture the entrances and/or exits of the store. In turn, the system of FIG. 1B may be used in lieu of or in conjunction with the system of FIG. 1A to process purchases of items by users that are customers in the store.

As shown in FIG. 1B, streams of images and/or depth data captured by cameras 122_{1-X} are encoded into consecutive fixed-size data chunks 126_{1-X}. For example, each of cameras 122_{1-X} may include and/or be coupled to a computing device that divides one or more streams of images and depth data generated by the camera into multiple data chunks that occupy the same amount of space and/or include the same number of frames of data. The “chunk size” of each data chunk may be selected to maximize the length of the data chunk while remaining within the available storage space on the computing device.

Data chunks 126_{1-X} from cameras 122_{1-X} are cached on local storage 124 that is physically located on the same premises as cameras 122_{1-X}, and subsequently transferred to a remote cloud storage 160 in an asynchronous manner. For example, each data chunk may be transferred from a corresponding camera to local storage 124 after the data chunk is created. Data chunks 126_{1-X} stored in local storage 124 may then be uploaded to cloud storage 160 in a first-in, first-out (FIFO) manner. Uploading of data chunks 126_{1-X} to cloud storage 160 may additionally be adapted to variable upload bandwidth and potential disruption of the network connection between local storage 124 and cloud storage 160.

Metadata for data chunks 126_{1-X} that are successfully uploaded to cloud storage 160 is stored in a number of metadata streams 128_{1-X} within a distributed stream-processing framework 120. In some embodiments, distributed stream-processing framework 120 maintains multiple streams of messages identified by a number of topics. Each topic is optionally divided into multiple partitions, with each partition storing a chronologically ordered sequence of messages.

Within distributed stream-processing framework 120, each of metadata streams 128_{1-X} is associated with a topic name that indicates the type of camera (e.g., tracking camera, shelf camera, checkout camera, entrance/exit camera, etc.) from which data chunks 126_{1-X} represented by the metadata in the metadata stream are generated. Each metadata stream is also assigned a partition key that identifies a camera and/or a physical store in which the camera is deployed.

Within distributed stream-processing framework 120, producers of metadata for data chunks 126_{1-X} (e.g., cameras 122_{1-X}, local storage 124, etc.) publish messages that include the metadata to metadata streams 128_{1-X} by providing the corresponding topic names and partition keys. Consumers of the metadata provide the same topic names and/or partition keys to distributed stream-processing framework 120 to retrieve the messages from metadata streams 128_{1-X} in the order in which the messages were written. By decoupling transmission of the messages from the producers from receipt of the messages by the consumers, distributed stream-processing framework 120 allows topics, streams, partitions, producers, and/or consumers to be dynamically added, modified, replicated, and removed without interfering with the transmission and receipt of messages using other topics, streams, partitions, producers, and/or consumers.

As shown, consumers of metadata streams 128_{1-X} include a number of processing nodes 134_{1-Y}. In one or more embodiments, processing nodes 134_{1-Y} include stateless worker processes on cloud instances with access to central processing unit (CPU) and/or graphics processing unit (GPU) resources. Each processing node included in processing nodes 134_{1-Y} may subscribe to one or more metadata streams 128_{1-X} in distributed stream-processing framework 120. In turn, each processing node included in processing nodes 134_{1-Y} retrieves metadata for one or more data chunks 126_{1-X} in chronological order from the metadata stream(s) to which the processing node subscribes, uses the metadata to download the corresponding data chunk(s) from cloud storage 160, performs one or more types of analysis on the retrieved data chunks, and publishes results of the analysis to one or more feature streams 130_{1-X} in distributed stream-processing framework 120.

In one or more embodiments, processing nodes 134_{1-Y} extract frame-level features from data chunks 126_{1-X}. This frame-level feature extraction varies with the type of cameras from which data chunks 126_{1-X} are received. As mentioned above, cameras 122_{1-X} include tracking cameras 102_{1-M}, shelf cameras 104_{1-N}, and/or checkout cameras 114_{1-O}. When a data chunk is generated by a shelf camera, frame-level shelf features 138 extracted from the data chunk include (but are not limited to) user and hand detections with associated stereo depth estimates, as well as estimates of optical flow for a given user across a certain number of frames. When a data chunk is generated by a tracking camera, checkout camera, entrance-exit camera, and/or another type of camera that monitors user movements and locations in the store, frame-level tracking features 140 extracted from the data chunk include (but are not limited to) estimates of a user's pose, embeddings representing visual “descriptors” of the user, and/or crops of the user within the data chunk.

After a processing node included in processing nodes 134_{1-Y} extracts a set of frame-level features from a data chunk, the processing node publishes the frame-level features to a topic that is prefixed by the role of the corresponding camera in distributed stream-processing framework 120. For example, the processing node may publish shelf features 138 extracted from frames captured by a shelf camera to a “shelf-features” topic, tracking features 140 extracted from frames captured by a tracking camera to a “tracking-features” topic, tracking features 140 extracted from frames captured by a camera that monitors an entrance or exit of the store to an “entrance-exit-features” topic, and tracking features 140 extracted from frames captured by a checkout camera to a “checkout-features” topic.

As with metadata streams 128_{1-X}, feature streams 130_{1-X} to which processing nodes 134_{1-Y} publish can be partitioned by camera. Further, each feature stream includes chronologically ordered frame-level features extracted from contiguous data chunks generated by a corresponding camera, thereby removing the “data chunk” artifact used to transmit data from local storage 124 to cloud storage 160 from subsequent processing.

As shown in FIG. 1B, an additional set of processing nodes 136_{1-W} performs processing related to different types of feature streams 130_{1-X}. As with processing nodes 134_{1-Y}, processing nodes 136_{1-W} include stateless worker processes on cloud instances with access to central processing unit (CPU) and/or graphics processing unit (GPU) resources. Processing nodes 136_{1-W} additionally publish the results of processing related to feature streams 130_{1-X} to a number of output streams 132_{1-Z} in distributed stream-processing framework 120.

More specifically, one subset of processing nodes 134_{1-Y} analyzes streams of features extracted from images captured by shelf cameras (e.g., one or more feature streams 130_{1-X} associated with the “shelf-features” topic) to generate shelf-affecting interaction (SAI) detections 142. SAI detections 142 include detected interactions between users and items offered for purchase on shelves of the store, such as (but not limited to) removal of an item from a shelf and/or placement of an item onto a shelf. Each SAI detection may be represented by a starting and ending timestamp, an identifier for a camera from which the SAI was captured, a tracklet of a user performing the SAI, one or more tracklets of the user's hands, an identifier for an item with which the user is interacting in the SAI, and/or an action perform by the user (e.g., taking the item from a shelf, putting the item onto a shelf, etc.). SAI detections 142 may then be published to one or more output streams 132_{1-Z} associated with a “sai-detection” topic in distributed stream-processing framework 120.

Another subset of processing nodes 134_{1-Y} analyzes streams of features extracted from images captured by tracking cameras (e.g., one or more feature streams 130_{1-X} associated with the “tracking-features” topic) to generate data related to user locations 144 in the store. This data includes (but is not limited to) tracklets of each user, a bounding box around the user, an identifier for the user, and a “descriptor” that includes an embedding representing the user's visual appearance. Data related to user locations 144 may then be published to one or more output streams 132_{1-Z} associated with a “user-locations” topic in distributed stream-processing framework 120.

A third subset of processing nodes 134_{1-Y} analyzes streams of features extracted from images captured by both the tracking cameras and shelf cameras (e.g., feature streams 130_{1-X} associated with the “shelf-features” and “tracking-features” topics) to generate user-SAI associations 146 that synchronize SAI detections 142 with user locations 144. These processing nodes 134_{1-Y} may use geometric techniques to match tracklets of interactions in SAI detections 142 to user tracklets from tracking cameras with overlapping views and store the matches in corresponding user-SAI associations 146. These processing nodes 134_{1-Y} also use crops of the users to associate each SAI detection with a shopper session represented by the most visually similar user.

A fourth subset of processing nodes 134_{1-Y} analyzes streams of features extracted from images captured by cameras that monitor the entrances and/or exits of the store (e.g., one or more feature streams 130_{1-X} associated with the “entrance-exit-features” topic) to generate entrance-exit detections 148 representing detections of users entering or exiting the store. When one of these processing nodes detects that that a user is entering the store (e.g., via analysis of a tracklet from a camera monitoring an entrance of the store), the processing node initiates a shopper session for the user and associates the shopper session with crops of the user. When one of these processing nodes detects that that a user is exiting the store (e.g., via analysis of a tracklet from a camera monitoring an exit of the store), the processing node finalizes the shopper session associated with crops of the user.

A fifth subset of processing nodes 134_{1-Y} analyzes streams of features extracted from images captured by checkout cameras (e.g., one or more feature streams 130_{1-X} associated with the “checkout-features” topic) to generate checkout associations 150. These checkout associations 150 include associations between checkout events, which are triggered by user interactions with checkout terminals and/or checkout devices, with shopper sessions based on visual similarity. These checkout associations 150 additionally include associations between each shopper session and payment and contact information for the corresponding user. This payment and contact information can be obtained from each user during the user's shopping session via a terminal device inside the store, a mobile application on the user's mobile device, and/or another means.

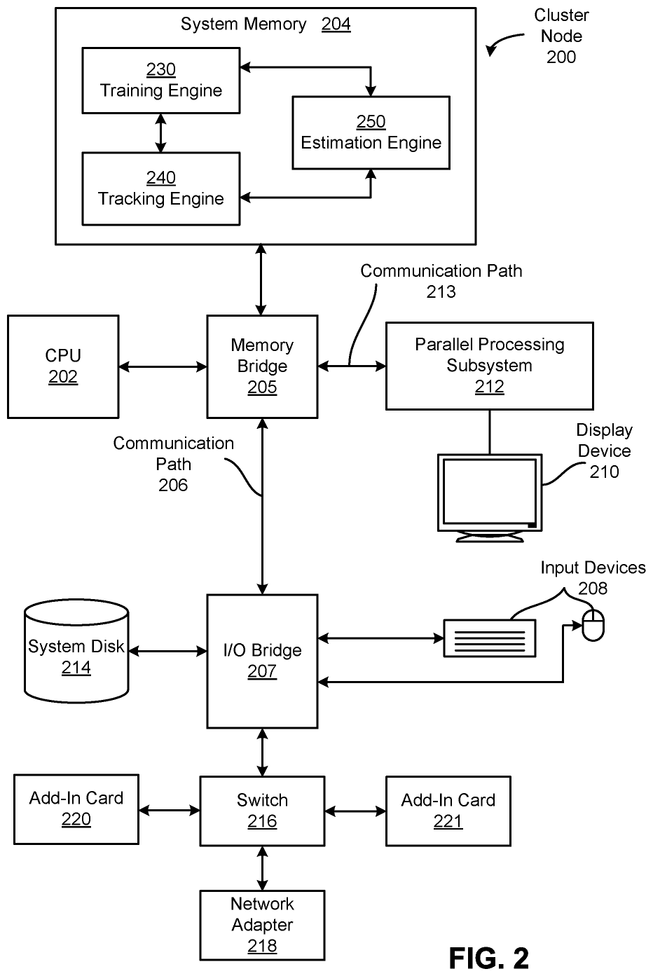

FIG. 2 is a more detailed illustration of a cluster node 200 in cluster 112 of FIG. 1A, according to various embodiments. In one or more embodiments, cluster node 200 includes a computer configured to perform processing related to operating an autonomous store. Cluster node 200 may be replicated in additional computers within cluster 112 to scale with the workload involved in operating the autonomous store. Some or all components of cluster node 200 may also, or instead, be implemented in checkout terminals, cloud instances, and/or other components of a system (e.g., the systems of FIGS. 1A and/or 1B) that operates the autonomous store.

As shown, cluster node 200 includes, without limitation, a central processing unit (CPU) 202 and a system memory 204 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In operation, I/O bridge 207 is configured to receive user input information from input devices 208, such as a keyboard or a mouse, and forward the input information to CPU 202 for processing via communication path 206 and memory bridge 205. Switch 216 is configured to provide connections between I/O bridge 207 and other components of cluster node 200, such as a network adapter 218 and various add-in cards 220 and 221.

I/O bridge 207 is coupled to a system disk 214 that may be configured to store content, applications, and data for use by CPU 202 and parallel processing subsystem 212. As a general matter, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to the I/O bridge 207 as well.

In various embodiments, memory bridge 205 may be a Northbridge chip, and I/O bridge 207 may be a Southbridge chip. In addition, communication paths 206 and 213, as well as other communication paths within cluster node 200, may be implemented using any technically suitable protocols, including, without limitation, AGP (Accelerated Graphics Port), HyperTransport, or any other bus or point-to-point communication protocol known in the art.

In some embodiments, parallel processing subsystem 212 includes a graphics subsystem that delivers pixels to a display device 210, which may be any conventional cathode ray tube, liquid crystal display, light-emitting diode display, or the like. In such embodiments, parallel processing subsystem 212 incorporates circuitry optimized for graphics and video processing, including, for example, video output circuitry. Such circuitry may be incorporated across one or more parallel processing units (PPUs) included within parallel processing subsystem 212. In other embodiments, parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 204 includes at least one device driver configured to manage the processing operations of the one or more PPUs within parallel processing subsystem 212.

In various embodiments, parallel processing subsystem 212 may be integrated with one or more of the other elements of FIG. 2 to form a single system. For example, parallel processing subsystem 212 may be integrated with CPU 202 and other connection circuitry on a single chip to form a system on chip (SoC).

It will be appreciated that the system shown herein is illustrative and that variations and modifications are possible. The connection topology, including the number and arrangement of bridges, the number of CPUs, and the number of parallel processing subsystems, may be modified as desired. For example, in some embodiments, system memory 204 could be connected to CPU 202 directly rather than through memory bridge 205, and other devices would communicate with system memory 204 via memory bridge 205 and CPU 202. In other alternative topologies, parallel processing subsystem 212 may be connected to I/O bridge 207 or directly to CPU 202, rather than to memory bridge 205. In still other embodiments, I/O bridge 207 and memory bridge 205 may be integrated into a single chip instead of existing as one or more discrete devices. Lastly, in certain embodiments, one or more components shown in FIG. 2 may not be present. For example, switch 216 could be eliminated, and network adapter 218 and add-in cards 220, 221 would connect directly to I/O bridge 207. In another example, display device 210 and/or input devices 208 may be omitted for some or all computers in cluster 112.

In some embodiments, cluster node 200 is configured to run a training engine 230, a tracking engine 240, and an estimation engine 250 that reside in system memory 204. Training engine 230, tracking engine 240, and estimation engine 250 may be stored in system disk 214 and/or other storage and loaded into system memory 204 when executed.

More specifically, estimation engine 250 generates estimates of pose and movement of customers and/or other users in the autonomous store. Training engine 230 uses the estimated poses and movements from estimation engine 250 to train one or more machine learning models to uniquely identify users in an autonomous store. Tracking engine 240 includes functionality to execute the machine learning model(s) in real-time or near-real-time to track the users and/or the users' interactions with items in the autonomous store. As described in further detail below, such training and/or tracking may be performed in a manner that is efficient and/or parallelizable, reduces the number of cameras in the autonomous store, and/or does not require manual calibration or adjustment of camera locations and/or poses.

### User Identification in Store Environments

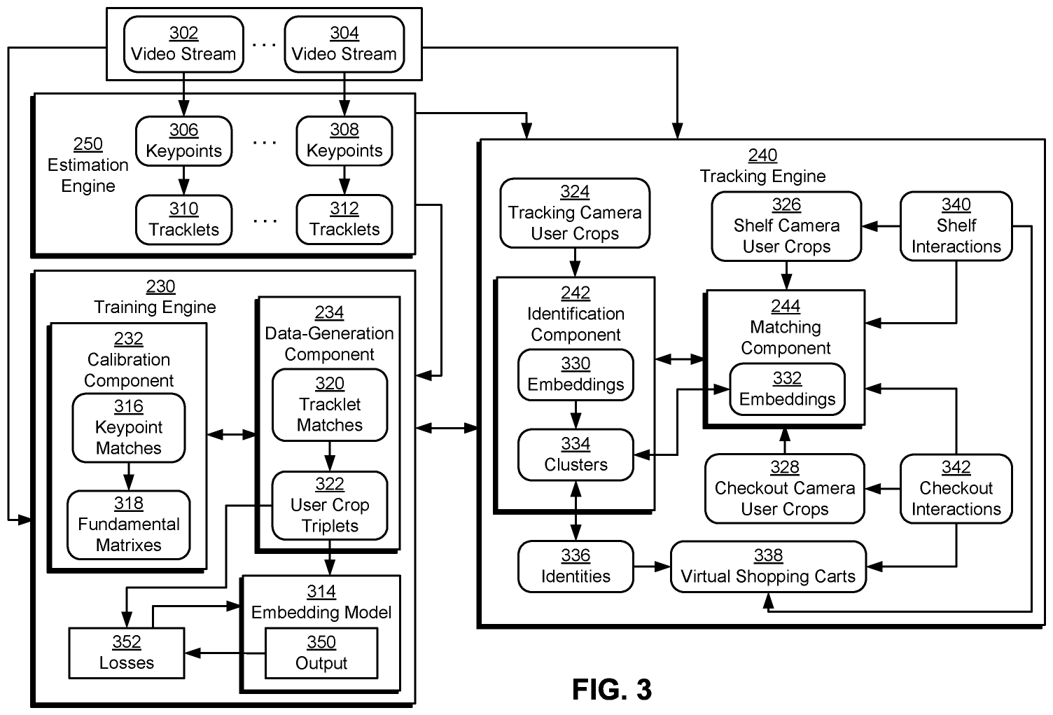

FIG. 3 is a more detailed illustration of training engine 230, tracking engine 240, and estimation engine 250 of FIG. 2, according to various embodiments. As shown, input into training engine 230, tracking engine 240, and estimation engine 250 includes a number of video streams 302.

Video streams 302-304 include sequences of images that are collected by cameras in an environment. In some embodiments, these cameras include, but are not limited to, tracking cameras (e.g., tracking cameras 102_{1-M} of FIG. 1A), shelf cameras (e.g., shelf cameras 104_{1-N} of FIG. 1A), checkout cameras (e.g., checkout cameras 114_{1-O} of FIG. 1A), and/or entrance/exit cameras in an autonomous store. Consequently, video streams 302-304 include images of users in various locations around the autonomous store, as captured by the tracking cameras; users interacting with items on shelves of the autonomous store, as captured by the shelf cameras; and/or users initiating or performing a checkout process before leaving the autonomous store, as captured by the checkout cameras. As described above with respect to FIG. 1B, video streams 302-304 may optionally be divided into contiguous data chunks prior to analysis by training engine 230, tracking engine 240, and/or estimation engine 250 (e.g., on an offline or batch-processing basis).

Alternatively or additionally, video streams 302-304 may include sequences of images that are captured by cameras in other types of indoor or outdoor environments. These video streams 302-304 may be analyzed by training engine 230, tracking engine 240, and estimation engine 250 to track users and/or the users' actions in the environments, as described in further detail below.

Estimation engine 250 analyzes video streams 302-304 to generate estimates of keypoints 306-308 in users shown within video streams 302-304. Keypoints 306-308 include spatial locations of joints and/or other points of interest that represent the poses (e.g., positions and orientations) of the users in frames of video streams 302-304. For example, each set of keypoints includes pixel locations of a user's nose, neck, right shoulder, right elbow, right wrist, left shoulder, left elbow, left wrist, right hip, right knee, right ankle, left hip left, knee, left ankle, right eye, left eye, right ear, and/or left ear in a frame of a video stream.

To generate keypoints 306-308, estimation engine 250 inputs individual frames from video streams 302-304 into a pose estimation model. For example, the pose estimation model includes a convolutional pose machine (CPM) with a number of stages that predict and refine heat maps containing probabilities of different types of keypoints 306-308 in pixels of each frame. After a final set of heat maps is outputted by the CPM, estimation engine 250 identifies each keypoint in a given set of keypoints (e.g., for a user in a frame) as the highest probability pixel location from the corresponding heat map.

Estimation engine 250 also uses estimates of keypoints 306-308 to generate estimates of tracklets 310-312 of keypoints 306-308 across consecutive frames in video streams 302-304. Each tracklet includes a sequence of keypoints for a user over a number of consecutive frames in a given video stream (i.e., from a single camera view). For example, each tracklet includes a number of “paths” representing the locations of a user's keypoints in a video stream as the user's movement is captured by a camera producing the video stream.

In one or more embodiments, estimation engine 250 uses an optimization technique to generate tracklets 310-312 from sets of keypoints 306-308 in consecutive frames of video streams 302-304. For example, estimation engine 250 may use the Hungarian method to match a first set of keypoints in a given frame of a video stream to a tracklet that contains a second set of keypoints in a previous frame of the video stream. In this example, the cost to be minimized is represented by the sum of the distances between respective keypoints in the two frames.

Estimation engine 250 additionally includes functionality to discontinue adding keypoints to a tracklet for a given user to reduce the likelihood that the tracklet is “contaminated” with keypoints from a different user (e.g., as the users pass one another and/or one or both users are occluded). For example, estimation engine 250 discontinues adding keypoints from subsequent frames in a video stream to an existing tracklet in the video stream when the velocity of the tracklet suddenly changes between frames, when the tracklet has not been updated for a certain prespecified number of frames, and/or when a technique for estimating the optical flow of the keypoints across frames deviates from the trajectory represented by the tracklet.

Training engine 230 includes functionality to train and/or update an embedding model 314 to generate output 350 that discriminates between visual representations of different users in the environment, independent of perspective, illumination, and/or partial occlusion. For example, embedding model 314 may include a residual neural network (ResNet), Inception module, and/or another type of convolutional neural network (CNN). The CNN includes one or more embedding layers that produce, as output 350, embeddings that are fixed-length vector representations of images or crops containing the users.

As shown, training engine 230 includes a calibration component 232 and a data-generation component 234. Each of these components is described in further detail below.

Calibration component 232 calculates fundamental matrixes 318 that describe geometric relationships and/or constraints between pairs of cameras with overlapping views of the environment. First, calibration component 232 generates keypoint matches 316 between keypoints 306-308 of the same user in synchronized video streams 302-304 from a given pair of cameras. For example, calibration component 232 matches a first series of keypoints representing joints and/or other locations of interest on a user in a first video stream captured by a first camera to a second series of keypoints for the same user in a second video stream captured by a second camera, which is synchronized with the first video stream. Each keypoint match is a correspondence representing two projections of the same 3D point on the user.

Next, calibration component 232 uses keypoint matches 316 to calculate fundamental matrixes 318 for the corresponding pairs of cameras. For example, calibration component 232 uses a random sample consensus (RANSAC) technique to solve a least-squares problem that calculates parameters of a fundamental matrix between a given camera pair in a way that minimizes the residuals between inlier keypoint matches 316 for the camera pair after linear projection with the parameters of the fundamental matrix.

In some embodiments, calibration component 232 calculates fundamental matrixes 318 using video streams 302-304 that capture a “calibrating user” and keypoint matches 316 from keypoints 306-308 of the calibrating user in video streams 302-304. For example, cameras in the environment are configured to generate video streams 302-304 as the calibrating user walks and/or moves around in the environment. In turn, estimation engine 250 generates keypoints 306-308 of the calibrating user in video streams 302-304, and training engine 230 identifies keypoint matches 316 between sets of these keypoints 306-308 in different video streams 302-304. A mobile device and/or another type of electronic device available to the calibrator may generate visual or other feedback indicating when calibration of a given camera pair is complete. The device additionally provides feedback indicating areas of the environment in which additional coverage is needed, which allows the calibrator to move to those areas for capture by cameras with views of the areas.

Data-generation component 234 generates training data for embedding model 314 from tracklet matches 320 between temporally concurrent tracklets 310-312 of the same users from different camera views. For example, tracklet matches 320 may be generated from tracklets 310-312 of users in video streams 302-304 after fundamental matrixes 318 are calculated for cameras from which video streams 302-304 are obtained. Each tracklet match includes two or more tracklets of the same user at the same time; these tracklets may be found in video streams representing different camera views of the user.

As with generation of tracklets 310-312 by estimation engine 250, data-generation component 234 may use an optimization technique to generate tracklet matches 320. For example, data-generation component 234 may use the Hungarian method to generate a tracklet match between a first tracklet from a first video stream captured by a first camera to a second tracklet from a second video stream captured by a second camera. In this example, the cost to be minimized is represented by the temporal intersection over union (IoU) between the two tracklets subtracted from 1, plus the average symmetric epipolar distance between keypoints in the two tracklets across the temporal intersection of the tracklets (as calculated using fundamental matrixes 318 between the two cameras). A threshold is also applied to the symmetric epipolar distance to avoid generating tracklet matches 320 from pairs of tracklets 310-312 that are obviously not from the same user.

Next, data-generation component 234 uses tracklet matches 320 to generate multiple user crop triplets 322 of users in video streams 302-304. Each user crop triplet includes three crops of users in video streams 302-304; each crop is generated as a minimum bounding box for a set of keypoints for a user in a frame from a video stream. The number of user crop triplets 322 generated may be selected based on the number of video streams 302-304, tracklets 310-312, tracklet matches 320, and/or other factors related to identifying and differentiating between users in the environment.

In addition, each user crop triplet includes an anchor sample, a positive sample, and a negative sample. The anchor sample includes a first crop of a first user, which is randomly selected from tracklets 310-312 associated with tracklet matches 320. The positive sample includes a second crop of the first user, which is randomly selected from all tracklets that are matched to the tracklet from which the first crop was obtained. The negative sample includes a third crop of a second user, which is randomly sampled from all tracklets that co-occur with the tracklet(s) from which the first and second crops were obtained but that are not matched with the tracklet(s) from which the first and second crops were obtained. Consequently, the positive sample is from the same class (i.e., the same user) as the anchor sample, and the negative sample is from a different class (i.e., a different user) than the anchor sample.

Training engine 230 then trains embedding model 314 using user crop triplets 322. More specifically, training engine 230 inputs the anchor, positive, and negative samples in each user crop triplet into embedding model 314 and obtains, as output 350 from embedding model 314, three embeddings representing the three samples. Training engine 230 also uses a loss function to calculate losses 352 associated with the outputted embeddings. For example, training engine 230 calculates a triplet, contrastive, or other type of ranking loss between the anchor and positive samples and the anchor and negative samples in each user crop triplet. The loss increases with the distance between the anchor and positive samples and decreases with the distance between the anchor and negative samples.

Training engine 230 then uses a training technique and/or one or more hyperparameters to update parameters of embedding model 314 in a way that reduces losses 352 associated with output 350 and user crop triplets 322. Continuing with the above example, training engine 230 uses stochastic gradient descent and backpropagation to iteratively calculate triplet, contrastive, or other ranking losses 352 for embeddings produced by embedding model 314 from user crop triplets 322 and update parameters (e.g., neural network weights) of embedding model 314 based on the derivatives of losses 352 until the parameters converge, a certain number of training iterations or epochs has been performed, and/or another criterion is met.

In some embodiments, training engine 230 supplements training of embedding model 314 using user crop triplets 322 generated from tracklet matches 320 in video streams 302-304 with additional training of embedding model 314 using out-of-domain (OOD) data collected from other environments. This OOD data can be used to bootstrap training of embedding model 314 and/or increase the diversity of training data for embedding model 314.

For example, the OOD data includes crops of users collected from images or video streams of similar environments (e.g., other store environments) and/or from publicly available datasets. Each crop is labeled with a unique identifier for the corresponding user. To train embedding model 314 using both user crop triplets 322 obtained from video streams 302-304 of the environment and the OOD data, training engine 230 may add, to embedding model 314, a softmax layer after an embedding layer that produces embeddings from individual crops in user crop triplets 322. The embeddings are fed into the softmax layer to produce additional output 350 containing predicted probabilities of different classes (e.g., users) in the crops.

Continuing with the above example, training engine 230 jointly trains embedding model 314 on the OOD data and in-domain user crop triplets 322. In particular, training engine 230 updates parameters of embedding model 314 using a target domain objective that includes the triplet, contrastive, or ranking loss associated with embeddings of user crop triplets 322 from in-domain video streams 302-304, as well as a cross-entropy loss associated with probabilities of users outputted by the softmax layer. In other words, training engine 230 includes functionality to train embedding model 314 using multiple training objectives, training datasets, and/or types of losses 352.

After embedding model 314 is trained, training engine 230 may validate the performance of embedding model 314 in a verification task (e.g., identifying a pair of crops as containing the same user or different users). For example, training engine 230 may input, into embedding model 314, a validation dataset that includes a balanced mixture of positive pairs of crops (e.g., crops of the same user) and negative pairs of crops (e.g., crops of different users) from the OOD dataset and/or video streams 302-304. Training engine 230 may then evaluate the performance of embedding model 314 in the task using an equal error rate (ERR) performance metric.

Tracking engine 240 uses embeddings 330-332 produced by the trained embedding model 314 to track and manage identities 336 of users in the environment. More specifically, tracking engine 240 analyzes video streams 302-304 collected by cameras in the environment in a real-time or near-real-time basis. Tracking engine 240 also obtains tracking camera user crops 324 as bounding boxes around keypoints 306-308 of individual users in one or more video streams 302-304 from tracking cameras (e.g., tracking cameras 102_{1-M} of FIG. 1A) in the environment.

Within tracking engine 240, an identification component 242 applies embedding model 314 to tracking camera user crops 324 to generate embeddings 330 of tracking camera user crops 324. Identification component 242 then groups embeddings 330 into clusters 334 and uses each cluster as an identity (e.g., identities 336) for a corresponding user.

For example, identification component 242 generates a new set of embeddings 330 from tracking camera user crops 324 whenever a new set of frames is available in video streams 302-304. Identification component 242 optionally aggregates (e.g., averages) a number of embeddings 330 from crops in the same tracklet into a single embedded representation of the user in the tracklet. This embedded representation acts as a visual “descriptor” for the user. Next, identification component 242 uses a clustering technique such as robust continuous clustering (RCC) to generate clusters 334 of the individual or aggregated embeddings 330, with each cluster containing a number of embeddings 330 that are closer to one another in the vector space than to embeddings 330 in other clusters. Identification component 242 also, or instead, adds embeddings 330 of user crops from the new set of frames to existing clusters 334 of embeddings 330 from previous sets of frames in video streams 302-304. After clusters 334 are generated, identification component 242 uses geometric constraints represented by fundamental matrixes 318 between pairs of cameras and/or tracklet matches 320 between tracklets 310-312 of the users to identify instances where embeddings 330 of users in different locations have been assigned to the same cluster and prune the erroneous cluster assignments (e.g., by removing, from a cluster, any embeddings 330 that do not belong to the user represented by the majority of embeddings 330 in the cluster).

As mentioned above, video streams 302-304 may be used to track unique users in an autonomous store. As a result, identification component 242 may generate clusters 334 from embeddings 330 in a way that accounts for the number of users entering or exiting the autonomous store. For example, identification component 242 may analyze one or more video streams 302-304 from cameras placed over entrances or exits in the autonomous store and/or keypoints 306-308 or tracklets 310-312 within these video streams 302-304 to detect users entering or leaving the autonomous store. When a user enters the autonomous store, identification component 242 increments a counter that tracks the number of users in the autonomous store and creates a new cluster and corresponding identity from embeddings 330 of the user's tracking camera user crops 324. When a user leaves the autonomous store, identification component 242 decrements the counter and deletes the cluster and/or identity associated with the user's visual appearance. In another example, identification component limits the existence of a given cluster and a corresponding user identity to a certain time period (e.g., a number of hours), which can be selected or tuned based on the expected duration of user activity in the autonomous store (e.g., the time period is longer for a larger store and shorter for a smaller store). In both examples, the number of users determined to be in the autonomous store is used as a parameter that controls or influences the number of clusters 334 and/or identities 336 associated with embeddings 330.

As shown, tracking engine 240 also associates each identity with a virtual shopping cart (e.g., virtual shopping carts 338). When a new user is identified (e.g., after a new cluster of embeddings 330 for the user is created), tracking engine 240 assigns a unique identifier to the user's cluster and creates a virtual shopping cart that is mapped to the identifier and/or cluster. For example, tracking engine 240 instantiates one or more data structures or objects representing the virtual shopping cart and stores the user's identifier and/or cluster in fields within the data structure(s) and/or object(s).

Tracking engine 240 also includes functionality to associate shelf interactions 340 between the users and items on shelves of the autonomous store with the users' identities 336 and virtual shopping carts 338. In some embodiments, tracking engine 240 detects shelf interactions 340 by tracking the locations and/or poses of the users and the users' hands in video streams 302-304 from shelf cameras (e.g., shelf cameras 104_{1-N} of FIG. 1A) in the autonomous store. When a hand performs a movement that matches the trajectory or other visual attributes of a predefined shelf interaction (e.g., retrieving an item from a shelf, placing an item onto a shelf, moving an item from one shelf location to another, etc.), matching component 244 matches the hand to a user captured in the same video stream (e.g., by an overhead shelf camera). For example, tracking engine 240 may associate the hand's location with the user to which the hand is closest over a period (e.g., a number of seconds) before, during, and/or after the shelf interaction.

After a hand performing a shelf interaction in a video stream from a shelf camera is associated to a user in the same video stream, a matching component 244 in tracking engine 240 obtains shelf camera user crops 326 as crops of the user in the video stream (e.g., as bounding boxes around keypoints 306-308 of the user in the video stream). Next, matching component 244 executes embedding model 314 to generate embeddings 332 of shelf camera user crops 326 of the user. Matching component 244 and/or identification component 242 then identify the cluster to which embeddings 332 belong. For example, matching component 244 may provide all embeddings 332 and/or an aggregate representation of embeddings 332 to identification component 242, and identification component 242 may perform the same clustering technique used to generate clusters 334 to identify the cluster to which embeddings 332 belong. Identification component 242 may additionally use geometric constraints associated with tracking camera user crops 324 and shelf camera user crops 326 to omit one or more clusters 334 as candidates for assigning embeddings 332 of the user (e.g., because the cluster(s) are generated from embeddings of crops of users in other locations).

Tracking engine 240 also classifies the item to which the shelf interaction is applied. For example, tracking engine 240 may input crops of images that capture the shelf interaction (e.g., crops that include the user's hand and at least a portion of the item) into one or more machine learning models, and the machine learning model(s) may generate output for classifying the item. The output includes, but is not limited to, predicted probabilities that various item classes representing distinct stock keeping units (SKUs) and/or categories of items (e.g., baked goods, snacks, produce, drinks, etc. in a grocery store) are present in the crops. If a given item class includes multiple predicted probabilities (e.g., from multiple machine learning models and/or by a machine learning model from multiple crops of the interaction), tracking engine 240 may combine the predicted probabilities (e.g., as an average, weighted average, etc.) into an overall predicted probability for the item class. Tracking engine 240 then identifies the item in the interaction as the item class with the highest overall predicted probability of appearing in the crops.

Tracking engine 240 then updates the virtual shopping cart associated with the cluster to which embeddings 332 are assigned to reflect the user's interaction with the identified item. More specifically, tracking engine 240 adds the item to the virtual shopping cart when the interaction is identified as removal of the item from a shelf. Conversely, tracking engine 240 removes the item from the virtual shopping cart when the interaction is identified as placement of the item onto a shelf. Thus, as the user browses or shops in the autonomous store, identification component 242 may update a cluster with additional embeddings 330 of tracking camera user crops 324 and/or shelf camera user crops 326 of the user, and matching component 244 may update the virtual shopping cart associated with the cluster based on the user's shelf interactions 340 with items in the autonomous store.

Tracking engine 240 additionally monitors one or more video streams 302-304 from checkout cameras (e.g., checkout cameras 114_{1-O} of FIG. 1A) for checkout interactions 342 between the users and checkout terminals in the autonomous store. In some embodiments, checkout interactions 342 include actions performed by the users to indicate intent to checkout with the autonomous store. For example, checkout interactions 342 include, but are not limited to, a user approaching a checkout terminal in the autonomous store, coming within a threshold proximity to a checkout terminal, maintaining proximity to the checkout terminal, facing the checkout terminal, and/or interacting with a user interface on the checkout terminal. These checkout interactions 342 may be detected by proximity sensors on or around the checkout terminals, analyzing video streams 302-304 from the checkout cameras, user interfaces on the checkout terminals, and/or other techniques.

When a checkout interaction is detected, matching component 244 obtains checkout camera user crops 328 as crops of the user in a video stream (e.g., as bounding boxes around keypoints 306-308 of the user in the video stream) from a checkout camera capturing the checkout interaction. As with association of shelf interactions 340 to virtual shopping carts 338, matching component 244 uses embedding model 314 to generate embeddings 332 of checkout camera user crops 328, and identification component 242 assigns the newly generated embeddings 332 and/or an aggregate representation of embeddings 332 to a cluster. Tracking engine 240 and/or another component then carry out the checkout process to finalize the purchase of items in the virtual shopping cart associated with the cluster. After the user has checked out and exited the autonomous store, identification component 242 may remove the cluster containing the user's embeddings (e.g., embeddings 330-332), delete the virtual shopping cart associated with the cluster, and/or decrement a counter tracking the number of users in the autonomous store.

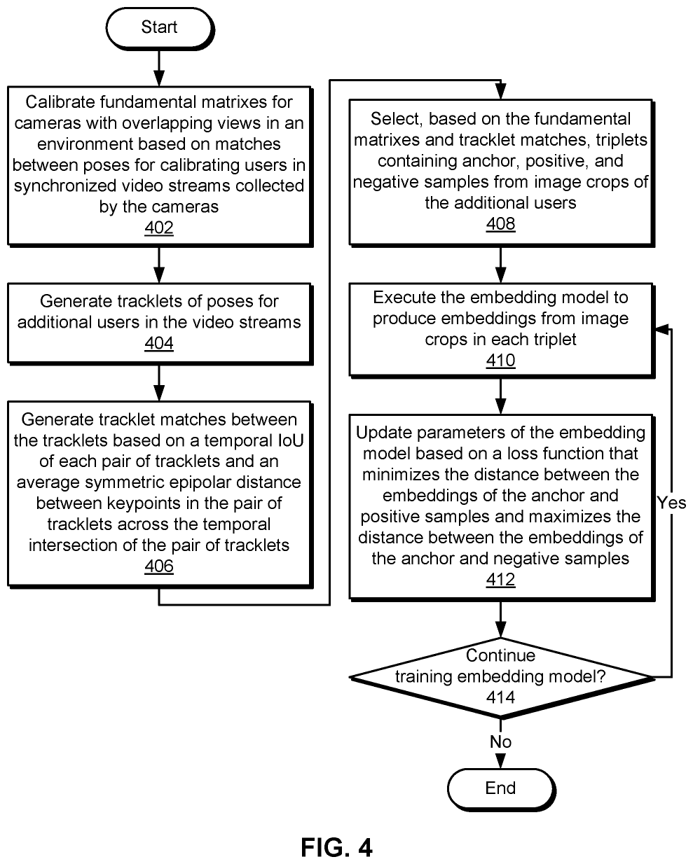

FIG. 4 is a flow chart of method steps for training an embedding model, according to various embodiments. Although the method steps are described in conjunction with the systems of FIGS. 1-3, persons skilled in the art will understand that any system configured to perform the method steps, in any order, is within the scope of the present invention.

As shown, training engine 230 calibrates 402 fundamental matrixes for cameras with overlapping views in an environment based on matches between poses for calibrating users in synchronized video streams collected by the cameras. For example, one or more calibrating users may walk around the environment and use a mobile device or application to receive visual or other feedback indicating areas of the environment in which additional coverage is needed. When a certain amount of footage (e.g., a certain number of frames) of a calibrating user has been collected by a pair of cameras with overlapping views, the user's mobile device or application is updated to indicate that coverage of the area covered by the pair of cameras is sufficient. After the video streams of the calibrating user(s) are collected, estimation engine 250 estimates poses of the user(s) as multiple sets of keypoints on the users in individual frames of the video streams. Calibration component 232 then matches the sets of keypoints between the synchronized video streams and determines the epipolar geometry between each camera pair with overlapping views in the environment by using a RANSAC technique to solve a least-squares problem that minimizes the residuals between inlier keypoint matches for the camera pair after linear projection with the parameters of the fundamental matrix.

Next, estimation engine 250 generates 404 tracklets of poses for additional users in the video streams. For example, estimation engine 250 generates a tracklet by matching a first set of keypoints for a user in a frame of a video stream to a second set of keypoints in a previous frame of the video stream based on a matching cost that includes a sum of distances between respective keypoints in the two sets of keypoints. Estimation engine 250 also discontinues matching of additional sets of keypoints to a tracklet based on a change in velocity between a set of keypoints and existing sets of keypoints in the tracklet, a lack of keypoints in the tracklet for a prespecified number of frames, and/or other criteria that indicate an increased likelihood that the tracklet is “contaminated” with keypoints from a different user.

Training engine 230 also generates 406 tracklet matches between the tracklets based on a temporal IoU of each pair of tracklets and an aggregate symmetric epipolar distance between keypoints in the pair of tracklets across the temporal intersection of the pair of tracklets. For example, training engine 230 uses a Hungarian method to generate tracklet matches as pairs of tracklets that represent different camera views of the same person at the same time. The matching cost for the Hungarian method includes the temporal IoU between a pair of tracklets subtracted from 1, which is added to the average symmetric epipolar distance between keypoints in the tracklets across the temporal intersection of the tracklets.

Training engine 230 selects 408, based on the fundamental matrixes and/or tracklet matches generated in operations 402-404, triplets containing anchor, positive, and negative samples from image crops of the additional users. For example, training engine 230 selects the anchor sample and the positive sample in each triplet from one or more tracklets of a first user and the negative sample from a tracklet of a second user.

Training engine 230 then executes 410 the embedding model to produce embeddings from image crops in each triplet and updates 412 parameters of the embedding model based on a loss function that minimizes the distance between the embeddings of the anchor and positive samples and maximizes the distance between the embeddings of the anchor and negative samples. For example, training engine 230 inputs image crops in each triplet into the embedding model to obtain three embeddings, with each embedding containing a fixed-length vector representation of a corresponding image crop. Training engine 230 then calculates a contrastive, triplet, and/or other type of ranking loss from distances between the embeddings of the anchor and positive samples and the embeddings of the anchor and negative samples. Training engine 230 then uses a training technique to update parameters of the embedding model in a way that reduces the loss.

During training of the embedding model, training engine 230 optionally inputs image crops from an external (e.g., OOD) dataset into the embedding model to produce embeddings of the image crops and adds a softmax layer to the embedding model to generate predicted probabilities of user classes from the embeddings. Training engine 230 then updates parameters of the embedding model to reduce the cross-entropy loss associated with the predicted probabilities. Thus, training engine 230 includes functionality to jointly train the embedding model using different types of losses for the in-domain triplets and OOD dataset.

Training engine 230 repeats operations 410-412 to continue 414 training the embedding model. For example, training engine 230 generates embeddings from image crops in the triplets and updates parameters of the embedding model to reduce losses associated with the embeddings for a certain number of training iterations and/or epochs and/or until the parameters converge.

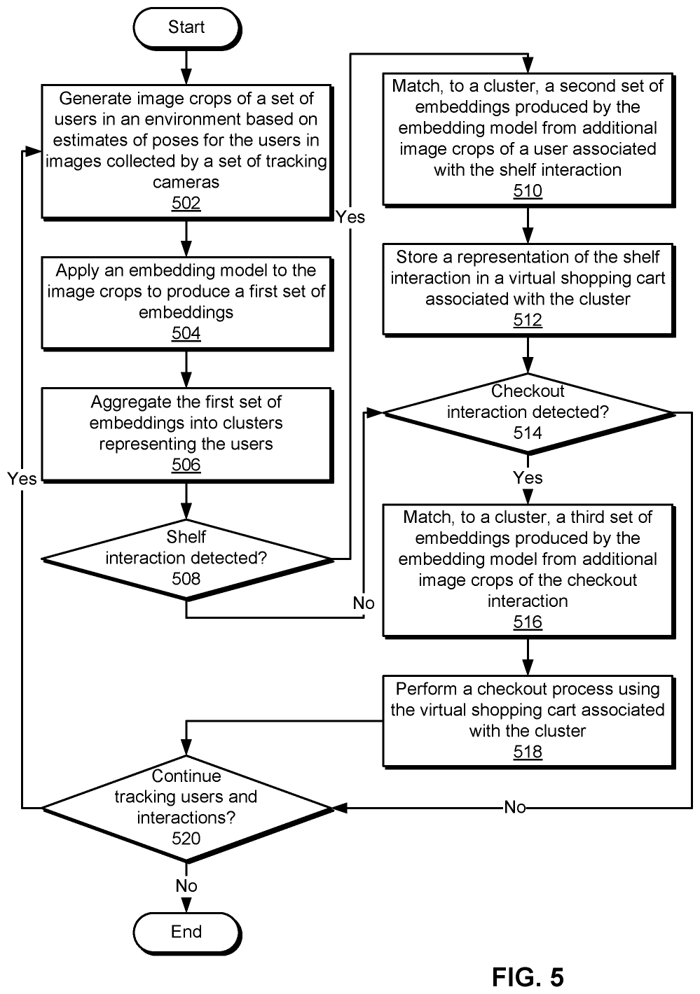

FIG. 5 is a flow chart of method steps for identifying users in an environment, according to various embodiments. Although the method steps are described in conjunction with the systems of FIGS. 1-3, persons skilled in the art will understand that any system configured to perform the method steps, in any order, is within the scope of the present invention.

As shown, estimation engine 250 and/or tracking engine 240 generate 502 image crops of a set of users in an environment (e.g., a store) based on estimates of poses for the users in images collected by a set of tracking cameras. For example, estimation engine 250 estimates the poses as sets of keypoints on the users within the images, and tracking engine 240 produces the image crops as minimum bounding boxes around individual sets of keypoints in the images.

Next, tracking engine 240 applies 504 an embedding model to the image crops to produce a first set of embeddings. For example, tracking engine 240 inputs the image crops into the embedding model produced using the flow chart of FIG. 4. In turn, the embedding model outputs the first set of embeddings as fixed-length vector representations of the image crops in a latent space.

Tracking engine 240 then aggregates 506 the first set of embeddings into clusters representing the users. For example, tracking engine 240 selects the number of clusters to generate by maintaining a counter that that is incremented when a user enters the environment and decremented when a user exits the environment. Tracking engine 240 uses RCC and/or another clustering technique to assign each embedding to a cluster. Tracking engine 240 also uses geometric constraints associated with the tracking cameras to remove embeddings that have been erroneously assigned to clusters (e.g., when an embedding assigned to a cluster is generated from an image crop of a location that is different from the location of other image crops associated with the cluster). After the clusters are generated, the clusters are used as representations of the users' identities in the environment.

Tracking engine 240 may detect 508 a shelf interaction between a user and an item on a shelf of the environment. For example, tracking engine 240 may identify a shelf interaction when a hand captured by a shelf camera in the environment performs a movement that matches the trajectory or other visual attributes of the shelf interaction. When no shelf interactions are detected, tracking engine 240 omits processing related to matching shelf interactions to users in the environment.

When a shelf interaction is detected, tracking engine 240 matches 510, to a cluster, a second set of embeddings produced by the embedding model from additional image crops of a user associated with the shelf interaction. For example, tracking engine 240 associates the user that is closest to the hand over a period before, during, and/or after the shelf interaction with the shelf interaction. Tracking engine 240 obtains keypoints and/or tracklets of the user during the shelf interaction from estimation engine 250 and uses the embedding model to generate embeddings of image crops of the keypoints. Tracking engine 240 then assigns the embeddings to a cluster produced in operation 506.

Tracking engine 240 also stores 512 a representation of the shelf interaction in a virtual shopping cart associated with the cluster. For example, tracking engine 240 adds an item involved in the shelf interaction to the virtual shopping cart when the shelf interaction is identified as removal of the item from a shelf. Alternatively, tracking engine 240 removes the item from the virtual shopping cart when the shelf interaction is identified as placement of the item onto a shelf.

Tracking engine 240 may also detect 514 a checkout interaction that indicates a user's intent to perform a checkout process. For example, tracking engine 240 may detect the checkout intent as the user approaching a checkout terminal, coming within a threshold proximity to the checkout terminal, maintaining the threshold proximity to the checkout terminal, interacting with a user interface of the checkout terminal, and/or performing another action. When no checkout interactions are detected, tracking engine 240 omits processing related to matching checkout interactions to users in the environment.

When a checkout interaction is detected, tracking engine 240 matches 516, to a cluster, a third set of embeddings produced by the embedding model from additional image crops of the checkout interaction. For example, tracking engine 240 obtains keypoints and/or tracklets of the user in a video stream of the checkout interaction from estimation engine 250 and uses the embedding model to generate embeddings of image crops of the keypoints. Tracking engine 240 then assigns the embeddings to a cluster produced in operation 506.

Tracking engine 240 and/or another component also perform 518 a checkout process using the virtual shopping cart associated with the cluster. For example, the component may receive payment information from the user, perform an electronic transaction that triggers payment for the items in the virtual shopping cart, and/or output a receipt for the payment. After the checkout process is complete and/or the user has exited the environment, the component may delete the cluster of embeddings associated with the user and/or decrement a counter tracking the number of users in the environment.

Tracking engine 240 may continue 520 tracking users and interactions in the environment. During such tracking, tracking engine 240 repeats operations 502-506 whenever a new set of images and/or one or more data chunks are generated by the tracking cameras. Tracking engine 240 also includes functionality to perform operations 508-512 and operations 514-518 in parallel with (or separately from) operations 502-506 to detect and process shelf interactions and checkout interactions in the environment.

In sum, the disclosed embodiments use embedded representations of users' visual appearances to identify and track the users in stores and/or other environments. An embedding model is trained to generate, from crops of the users, embeddings in a latent space that is discriminative between different people independent of perspective, illumination, and partial occlusion. After the embedding model is trained, embeddings produced by the embedding model from additional user crops are grouped into clusters representing identities of the corresponding users. Shelf interactions between the users and items on shelves of the stores and/or checkout interactions performed by the users to initiate a checkout process are matched to the identities by assigning embeddings produced by the embedding model from crops of the users in the interactions to the clusters. After a shelf interaction is matched to a cluster, a virtual shopping cart associated with the cluster is updated to include or exclude the item to which the shelf interaction is applied. Similarly, after a checkout interaction is matched to a cluster, the checkout process is performed using the virtual shopping cart associated with the cluster.

Because the users are identified using embeddings that reflect the users' visual appearances as captured by cameras in the environment, the users can be tracked within the environment without requiring comprehensive coverage of the environment by the cameras. Moreover, training of the embedding model using triplets that contain crops of users within the environment adapts the embedding model to images collected by the cameras and/or the conditions of the environment, thereby improving the accuracy of identities associated with clusters of embeddings outputted by the embedding model. The calculation of geometric constraints between pairs of cameras additionally allows triplets containing positive, negative, and anchor samples to be generated from tracklets of the users captured by the cameras, as well as the pruning of embeddings that have been erroneously assigned to certain clusters. Finally, the use of embeddings from the embedding model to match shelf and checkout interactions in the environment to the users' identities allows the users' movement and actions in the environment to be tracked in a stateless, efficient manner, which reduces complexity and/or resource overhead over conventional techniques that perform tracking via continuous user tracks and require multi-view coverage throughout the environments and accurate calibration between cameras. Consequently, the disclosed techniques provide technological improvements in computer systems, applications, and/or techniques for uniquely identifying and tracking users, associating user actions with user identities, and/or operating autonomous stores.

1. In some embodiments, a method comprises generating a first set of image crops of a first set of users in an environment based on estimates of a first set of poses for the first set of users in a first set of images collected by a set of tracking cameras, applying an embedding model to the first set of image crops to produce a first set of embeddings, aggregating the first set of embeddings into a set of clusters representing the first set of users, and upon matching, to a cluster, a second set of embeddings produced by the embedding model from a second set of image crops of an interaction between a user and an item, storing a representation of the interaction in a virtual shopping cart associated with the cluster.

2. The method of clause 1, further comprising upon matching, to the cluster, a third set of embeddings produced by the embedding model from a third set of image crops of the user initiating a checkout process, performing the checkout process using the virtual shopping cart associated with the cluster.

3. The method of clauses 1 or 2, further comprising generating the third set of image crops from a second set of images collected by a checkout camera.

4. The method of any of clauses 1-3, further comprising selecting triplets from a second set of image crops of a second set of users, wherein each of the triplets comprises an anchor sample comprising a first image crop of a first user, a positive sample comprising a second image crop of the first user, and a negative sample comprising a third image crop of a second user, executing the embedding model to produce a first embedding from the first image crop, a second embedding from the second image crop, and a third embedding from the third image crop, and updating parameters of the embedding model based on a loss function that minimizes a first distance between the first and second embeddings and maximizes a second distance between the first and third embeddings.

5. The method of any of clauses 1-4, wherein selecting the triplets comprises calibrating fundamental matrixes for pairs of cameras with overlapping views in the set of tracking cameras based on matches between a second set of poses for one or more calibrating users in a set of synchronized video streams from the set of tracking cameras, generating tracklets of a third set of poses for a second set of users in the set of synchronized video streams, and selecting, based on the fundamental matrixes, the anchor sample and the positive sample from one or more tracklets of a first user and the negative sample from a tracklet of a second user.

6. The method of any of clauses 1-5, wherein selecting the triplets further comprises generating tracklet matches between the tracklets based on a temporal intersection over union (IoU) of a pair of tracklets and an aggregate symmetric epipolar distance between keypoints in the pair of tracklets across the temporal intersection of the tracklets.

7. The method of any of clauses 1-6, wherein generating the tracklets comprises matching a first set of keypoints for a user in a frame of a video stream to a second set of keypoints in a previous frame of the video stream based on a matching cost comprising a sum of distances between respective keypoints in the first set of keypoints and the second set of keypoints.

8. The method of any of clauses 1-7, wherein generating the tracklets further comprises discontinuing matching of additional sets of keypoints to a tracklet based on at least one of a change in velocity between a set of keypoints and existing sets of keypoints in the tracklet, and a lack of keypoints in the tracklet for a prespecified number of frames.

9. The method of any of clauses 1-8, further comprising updating the parameters of the embedding model based on a cross-entropy loss associated with probabilities of classes outputted by the embedding model from additional embeddings for a third set of users.

10. The method of any of clauses 1-9, wherein generating the first set of image crops comprises applying a pose estimation model to the first set of images to produce the estimates of the first set of poses as multiple sets of keypoints for the first set of users in the first set of images, and generating the first set of image crops as bounding boxes for individual sets of keypoints in the multiple sets of keypoints.

11. The method of any of clauses 1-10, wherein aggregating the first set of embeddings into the set of clusters comprises selecting a number of clusters to generate by tracking a number of users entering and exiting the environment.

12. The method of any of clauses 1-11, wherein aggregating the first set of embeddings into the set of clusters comprises removing an embedding from the cluster based on geometric constraints associated with the set of tracking cameras.

13. In some embodiments, a non-transitory computer readable medium stores instructions that, when executed by a processor, cause the processor to perform the steps of generating a first set of image crops of a first set of users in an environment based on estimates of a first set of poses for the first set of users in a first set of images collected by a set of tracking cameras, applying an embedding model to the first set of image crops to produce a first set of embeddings, aggregating the first set of embeddings into a set of clusters representing the first set of users, and upon matching, to a cluster, a second set of embeddings produced by the embedding model from a second set of image crops of an interaction between a user and an item, storing a representation of the interaction in a virtual shopping cart associated with the cluster.

14. The non-transitory computer readable medium of clause 13, wherein the steps further comprise upon matching, to the cluster, a third set of embeddings produced by the embedding model from a third set of image crops of the user initiating a checkout process, performing the checkout process using the virtual shopping cart associated with the cluster.

15. The non-transitory computer readable medium of clauses 13 or 14, wherein the steps further comprise selecting triplets from a second set of image crops of a second set of users, wherein each of the triplets comprises an anchor sample comprising a first image crop of a first user, a positive sample comprising a second image crop of the first user, and a negative sample comprising a third image crop of a second user, executing the embedding model to produce a first embedding from the first image crop, a second embedding from the second image crop, and a third embedding from the third image crop, and updating parameters of the embedding model based on a loss function that minimizes a first distance between the first and second embeddings and maximizes a second distance between the first and third embeddings.

16. The non-transitory computer readable medium of any of clauses 13-15, wherein selecting the triplets comprises calibrating fundamental matrixes for pairs of cameras with overlapping views in the set of tracking cameras based on matches between a second set of poses for one or more calibrating users in a set of synchronized video streams collected by the set of tracking cameras, generating tracklets of a third set of poses for a second set of users in the set of synchronized video streams, generating tracklet matches between the tracklets based on a temporal intersection over union (IoU) of a pair of tracklets and an aggregate symmetric epipolar distance between keypoints in the pair of tracklets across the temporal intersection of the tracklets, and selecting, based on the tracklet matches, the anchor sample and the positive sample from one or more tracklets of a first user and the negative sample from a tracklet of a second user.

17. The non-transitory computer readable medium of any of clauses 13-16, wherein generating the tracklets comprises matching a first set of keypoints for a user in a frame of a video stream to a second set of keypoints in a previous frame of the video stream based on a matching cost comprising a sum of distances between respective keypoints in the first set of keypoints and the second set of keypoints.

18. The non-transitory computer readable medium of any of clauses 13-17, wherein generating the tracklets comprises discontinuing matching of additional sets of keypoints to a tracklet based on at least one of a change in velocity between a set of keypoints and existing sets of keypoints in the tracklet, and a lack of keypoints in the tracklet for a prespecified number of frames.

19. The non-transitory computer readable medium of any of clauses 13-18, wherein generating the first set of image crops comprises applying a pose estimation model to the first set of images to produce the estimates of the first set of poses as multiple sets of keypoints for the first set of users in the first set of images, and generating the first set of image crops as bounding boxes for individual sets of keypoints in the multiple sets of keypoints.

20. In some embodiments, a system comprises a memory that stores instructions, and a processor that is coupled to the memory and, when executing the instructions, is configured to generate a first set of image crops of a first set of users in an environment based on estimates of a first set of poses for the first set of users in a first set of images collected by a set of tracking cameras, apply an embedding model to the first set of image crops to produce a first set of embeddings, aggregate the first set of embeddings into a set of clusters representing the first set of users, and upon matching, to a cluster, a second set of embeddings produced by the embedding model from a second set of image crops of an interaction between a user and an item, store a representation of the interaction in a virtual shopping cart associated with the cluster.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method, comprising:
generating a first set of image crops of a first set of users in an environment based on estimates of a first set of poses for the first set of users in a first set of images collected by a set of tracking cameras;
applying an embedding model to the first set of image crops to produce a first set of embeddings;
aggregating the first set of embeddings into a set of clusters representing the first set of users; and
upon matching, to a cluster, a second set of embeddings produced by the embedding model from a second set of image crops of an interaction between a user and an item, storing a representation of the interaction in a virtual shopping cart associated with the cluster.

2. The method of claim 1, further comprising upon matching, to the cluster, a third set of embeddings produced by the embedding model from a third set of image crops of the user initiating a checkout process, performing the checkout process using the virtual shopping cart associated with the cluster.

3. The method of claim 2, further comprising generating the third set of image crops from a second set of images collected by a checkout camera.

4. The method of claim 1, further comprising:
selecting triplets from a second set of image crops of a second set of users, wherein each of the triplets comprises an anchor sample comprising a first image crop of a first user, a positive sample comprising a second image crop of the first user, and a negative sample comprising a third image crop of a second user;
executing the embedding model to produce a first embedding from the first image crop, a second embedding from the second image crop, and a third embedding from the third image crop; and
updating parameters of the embedding model based on a loss function that minimizes a first distance between the first and second embeddings and maximizes a second distance between the first and third embeddings.

5. The method of claim 4, wherein selecting the triplets comprises:
calibrating fundamental matrixes for pairs of cameras with overlapping views in the set of tracking cameras based on matches between a second set of poses for one or more calibrating users in a set of synchronized video streams from the set of tracking cameras;
generating tracklets of a third set of poses for a second set of users in the set of synchronized video streams; and
selecting, based on the fundamental matrixes, the anchor sample and the positive sample from one or more tracklets of a first user and the negative sample from a tracklet of a second user.

6. The method of claim 5, wherein selecting the triplets further comprises generating tracklet matches between the tracklets based on a temporal intersection over union (IoU) of a pair of tracklets and an aggregate symmetric epipolar distance between keypoints in the pair of tracklets across the temporal intersection of the tracklets.

7. The method of claim 5, wherein generating the tracklets comprises matching a first set of keypoints for a user in a frame of a video stream to a second set of keypoints in a previous frame of the video stream based on a matching cost comprising a sum of distances between respective keypoints in the first set of keypoints and the second set of keypoints.

8. The method of claim 7, wherein generating the tracklets further comprises discontinuing matching of additional sets of keypoints to a tracklet based on at least one of:
a change in velocity between a set of keypoints and existing sets of keypoints in the tracklet; and
a lack of keypoints in the tracklet for a prespecified number of frames.

9. The method of claim 4, further comprising updating the parameters of the embedding model based on a cross-entropy loss associated with probabilities of classes outputted by the embedding model from additional embeddings for a third set of users.

10. The method of claim 1, wherein generating the first set of image crops comprises:
applying a pose estimation model to the first set of images to produce the estimates of the first set of poses as multiple sets of keypoints for the first set of users in the first set of images; and
generating the first set of image crops as bounding boxes for individual sets of keypoints in the multiple sets of keypoints.

11. The method of claim 1, wherein aggregating the first set of embeddings into the set of clusters comprises selecting a number of clusters to generate by tracking a number of users entering and exiting the environment.

12. The method of claim 1, wherein aggregating the first set of embeddings into the set of clusters comprises removing an embedding from the cluster based on geometric constraints associated with the set of tracking cameras.

13. A non-transitory computer readable medium storing instructions that, when executed by a processor, cause the processor to perform the steps of:
generating a first set of image crops of a first set of users in an environment based on estimates of a first set of poses for the first set of users in a first set of images collected by a set of tracking cameras;
applying an embedding model to the first set of image crops to produce a first set of embeddings;
aggregating the first set of embeddings into a set of clusters representing the first set of users; and
upon matching, to a cluster, a second set of embeddings produced by the embedding model from a second set of image crops of an interaction between a user and an item, storing a representation of the interaction in a virtual shopping cart associated with the cluster.

14. The non-transitory computer readable medium of claim 13, wherein the steps further comprise upon matching, to the cluster, a third set of embeddings produced by the embedding model from a third set of image crops of the user initiating a checkout process, performing the checkout process using the virtual shopping cart associated with the cluster.

15. The non-transitory computer readable medium of claim 13, wherein the steps further comprise:
selecting triplets from a second set of image crops of a second set of users, wherein each of the triplets comprises an anchor sample comprising a first image crop of a first user, a positive sample comprising a second image crop of the first user, and a negative sample comprising a third image crop of a second user;
executing the embedding model to produce a first embedding from the first image crop, a second embedding from the second image crop, and a third embedding from the third image crop; and
updating parameters of the embedding model based on a loss function that minimizes a first distance between the first and second embeddings and maximizes a second distance between the first and third embeddings.

16. The non-transitory computer readable medium of claim 15, wherein selecting the triplets comprises:
calibrating fundamental matrixes for pairs of cameras with overlapping views in the set of tracking cameras based on matches between a second set of poses for one or more calibrating users in a set of synchronized video streams collected by the set of tracking cameras;
generating tracklets of a third set of poses for a second set of users in the set of synchronized video streams;
generating tracklet matches between the tracklets based on a temporal intersection over union (IoU) of a pair of tracklets and an aggregate symmetric epipolar distance between keypoints in the pair of tracklets across the temporal intersection of the tracklets; and
selecting, based on the tracklet matches, the anchor sample and the positive sample from one or more tracklets of a first user and the negative sample from a tracklet of a second user.

17. The non-transitory computer readable medium of claim 16, wherein generating the tracklets comprises matching a first set of keypoints for a user in a frame of a video stream to a second set of keypoints in a previous frame of the video stream based on a matching cost comprising a sum of distances between respective keypoints in the first set of keypoints and the second set of keypoints.

18. The non-transitory computer readable medium of claim 16, wherein generating the tracklets comprises discontinuing matching of additional sets of keypoints to a tracklet based on at least one of:
a change in velocity between a set of keypoints and existing sets of keypoints in the tracklet; and
a lack of keypoints in the tracklet for a prespecified number of frames.

19. The non-transitory computer readable medium of claim 13, wherein generating the first set of image crops comprises:
applying a pose estimation model to the first set of images to produce the estimates of the first set of poses as multiple sets of keypoints for the first set of users in the first set of images; and
generating the first set of image crops as bounding boxes for individual sets of keypoints in the multiple sets of keypoints.

20. A system, comprising:
a memory that stores instructions, and
a processor that is coupled to the memory and, when executing the instructions, is configured to:
generate a first set of image crops of a first set of users in an environment based on estimates of a first set of poses for the first set of users in a first set of images collected by a set of tracking cameras;
apply an embedding model to the first set of image crops to produce a first set of embeddings;
aggregate the first set of embeddings into a set of clusters representing the first set of users; and
upon matching, to a cluster, a second set of embeddings produced by the embedding model from a second set of image crops of an interaction between a user and an item, store a representation of the interaction in a virtual shopping cart associated with the cluster.
